(19) United States
(12) Patent Application Publication
(10) Pub. No.: US 2005/0169590 A1
(43) Pub. Date: Aug. 4, 2005

(54) Liquid crystal infiltrated optical fibre, method of its production, and use thereof

(75) Inventor: Thomas Tanggaard Alkeskjold, Jyllinge (DK)

Correspondence Address: BURNS DOANE SWECKER & MATHIS L L P, POST OFFICE BOX 1404, ALEXANDRIA, VA, 22313-1404, US

(73) Assignee: Crystal Fibre A/S, Birkerod (DK)

(21) Appl. No.: 11/025,137

(22) Filed: Dec. 30, 2004

Related U.S. Application Data
(60) Provisional application No. 60/536,718, filed on Jan. 16, 2004.

(30) Foreign Application Priority Data
Dec. 31, 2003 (DK) PA 2003-01953

(51) Int. Cl. G02B 6/16

(52) U.S. Cl. 385/123

(57) ABSTRACT

An optical fiber having a longitudinal direction and a cross-section perpendicular thereto, the optical fiber includes a core region; and a micro-structured cladding region, the cladding region surrounding the core region and having longitudinally extending micro-structure cladding elements arranged in a background cladding material, the micro-structured cladding elements having cross-sectional sizes which are equal or different, at least a number of the cladding elements being arranged in a substantially two dimensional periodic manner or a Bragg-type of manner, such as concentric rings of cladding elements surrounding the core, and the at least a number of the cladding elements are filled in at least one longitudinally extending section of the optical fiber with a liquid crystal material. The at least one filled section exhibits a photonic bandgap effect for at least one phase state of the liquid crystal.

### CROSS-REFERENCE TO RELATED APPLICATIONS

The present application claims the benefit of Danish Patent Application No. PA 2003-01953 filed in Denmark on Dec. 31, 2003, and U.S. Provisional Application No. 60/536,718, filed in the United States on Jan. 16, 2004, the entire contents of which are hereby incorporated herein by reference.

### BACKGROUND OF THE INVENTION

The present invention relates to optical fibre wave guides with tuneable optical properties, and use thereof in various applications, such as optical switching, dispersion compensation, wavelength conversion, polarization control, polarization delay lines (birefringent elements) sensors, attenuators, filters, amplifiers, and lasers; in particular the invention relates to optical fibres and devices that have optical properties that are tuneable using optical, thermal and/or electrical control.

### THE TECHNICAL FIELD

Optical fibres with tuneable optical properties are desired within a vast number of technical areas, ranging from optical communications, sensor technology, spectroscopy, imaging, lithography, medicine, material processing, micro-machining, and many others. Often it is desired to control light propagation through the optical fibre on a short time scale and preferably over a range of optical wavelengths. This applies to both continuous wave and pulsed operation.

For optical telecommunications, for example, it is desired to transmit light signals at high bit rates over long distances. This requires short light pulses of high intensity and optical transmission fibres wherein little or no pulse distortion occurs. The most common causes of pulse distortion are dispersion and/or non-linear effects. Therefore, as optical transmission systems are being pushed towards higher bit rates, there is a need for developing optical fibres with special waveguiding properties, for example large dispersion for reshaping of pulses, and preferably tuneable dispersion properties.

Within recent years a new type of optical fibre has been demonstrated that is capable of guiding light in a core surrounded by micro-structured elements that are elongated in the longitudinal direction of the fibres. These new fibres are referred to by a number of different names including photonic crystal fibres (PCF), micro-structured fibres, holey fibres, photonic bandgap fibres, and hole-assisted fibres. PCFs and aspects related to simulation, modelling, designing, fabricating and their use are extensively described by Bjarklev et al. in “Photonic crystal fibres”, Kluwer Academic Press, 2003 that is incorporated herein by reference. Optical fibres without micro-structured elements shall be referred to as standard optical fibres (such as traditional optical fibres that have been used and developed over several decades).

Although existing PCFs and devices using such optical fibres have a number of advantageous properties, it is desired to provide fibres and devices with improved properties in terms of tuneable optical properties, for example for switching, preferably with high sensitivity and/or practical solutions. This is desired in order to provide fast temporal response and/or low powers of control signals. In particular, it is desired to provide fibres and device that may be tuned and/or switched using optical means.

### RELATED ART DISCLOSURES

Litchinitser et al., “Antiresonant reflecting photonic crystal optical waveguides” Opt. Lett. 27, 1592-1594 (200) disclose a photonic bandgap fibre. It is a disadvantage of the disclosed fibres that the optical properties are not tuneable.

Abeeluck et al., “Analysis of spectral characteristics of photonic bandgap waveguides”, Opt. Express 10, 1320-1333 (2002) disclose other photonic bandgap fibres. It is a disadvantage of the disclosed fibres that the optical properties are not tuneable.

Bise et al., “Tuneable photonic band gap fiber” in OSA Trends in Optics and Photonics (TOPS) Vol. 70, Optical Fiber Communication Conference, Technical Digest, Postconference Edition (Optical Society of America, Washington D.C., 2002), pp. 466-468 disclose a tuneable photonic bandgap fibre. It is a disadvantage of the disclosed fibres that the optical properties are not tuneable without the use of relatively high temperature variations. It is a further disadvantage that the optical properties are not optically or electrically tuneable and that no means for optical or electrical tuning are disclosed.

Jasapara et al., “Effect of Mode Cut-Off on Dispersion in Photonic Bandgap Fibers”, Optical Fiber Communication Conference Thl3 (2003) disclose other photonic bandgap fibres. It is a disadvantage of the disclosed fibres that the optical properties are not tuneable without the use of relatively high temperature variations. It is a further disadvantage that the optical properties are not optically or electrically tuneable and that no means for optical or electrical tuning are disclosed.

Westbrook, et al., “Cladding-mode resonances in hybrid polymer-silica micro-structured optical fiber gratings”, IEEE Photonics Technol. Lett. 12, (2000) disclose micro-structured fibres comprising polymers in the cladding. It is a disadvantage of the disclosed fibres that the optical properties are not tuneable without the use of relatively high temperature variations. It is a disadvantage that the disclosed fibres are not optimised for providing photonic bandgab effect. It is a further disadvantage that the optical properties are not optically or electrically tuneable and that no means for optical or electrical tuning are disclosed.

Eggleton et al., “Micro-structured optical fiber devices”, Optics Express 9, 698-713 (2001) disclose micro-structured fibres comprising polymers in the cladding. It is a disadvantage that the disclosed fibres are not optimised for providing photonic bandgap effect. It is a further disadvantage that the optical properties are not optically or electrically tuneable and that no means for optical or electrically tuning are disclosed.

Eggelton et al., EP 1213594 disclose micro-structured fibres with polymer dispersed liquid crystals disposed in the core and/or cladding and/or exterior of the cladding. It is a disadvantage that the fibres are not optimized for providing photonic bandgap effect. It is a further disadvantage that the optical properties are not optically tuneable and that no means for optical tuning are disclosed. It is a disadvantage that the filling material is an emulsion of two materials, which could make manufacturing more difficult.

Larsen et al., “Dynamic waveguiding in photonic crystal fibers”, MC2 conference, Gothenburg, Sweden, February 2003 disclose PCFs comprising liquid crystals. It is a disadvantage that the fibres are not optimized for providing photonic bandgap effect. It is a further disadvantage that the optical properties are not optically tuneable and that no means for optical tuning are disclosed.

Larsen et al., “A Novel Photonic Crystal Fibre Switch”, Conference on Lasers and Electro Optics CLEO/Europe'03, Post Deadline paper (Munich, June 2003) disclose PCFs comprising liquid crystals. It is a disadvantage that no means for optical tuning are disclosed.

Larsen et al., “Tuneable Photonic BandGaps In a Photonic Crystal Fiber Filled With a Cholesteric Liquid Crystal”, 29th European Conference on Optical Communication ECOC'03 (Rimini, Italy, September 2003) disclose PCFs comprising liquid crystals. It is a disadvantage that no means for optical tuning are disclosed.

Larsen et al., “Optical devices based on liquid crystal photonic bandgap fibres,” Opt. Express 11, 2589-2596 (2003) disclose PCFs comprising liquid crystals. It is a disadvantage that no means for optical tuning are disclosed.

Larsen et al., “Thermo-optic switching in liquid crystal infiltrated photonic bandgap fibres”, IEEE Electronics Letters Vol. 39, No. 24 (2003) disclose PCFs comprising liquid crystals. It is a disadvantage that no means for optical tuning are disclosed.

Larsen et al., “Low-Voltage Optical Devices based on Liquid Crystal Photonic BandGap Fibres,” Applied Nanoscience, in press (2004) disclose PCFs comprising liquid crystals. It is a disadvantage that no means for optical tuning are disclosed.

### OBJECTS AND SUMMARY

It is an object of the present invention to provide an improved micro-structured optical fibre with tuneable or controllable optical properties.

It is an object of the present invention to provide an improved PBG fibre with tuneable or controllable optical properties.

It is a further object of the present invention to provide an improved PBG fibre with optically tuneable or controllable optical properties.

It is a further object of the present invention to provide tuneable optical fibres of short length, and compact tuneable optical devices.

It is a further object of the present invention to provide tuneable optical fibres with low loss, and tuneable optical devices with low insertion loss.

It is a further object of the present invention to provide optically, tuneable optical fibres, and optically tuneable optical devices.

It is a further object of the present invention to provide optically, tuneable optical fibres, and optically tuneable optical devices that may be connected to other optical components. In particular, such fibres and devices that may be spliced to other optical fibres.

It is a further object of the present invention to provide devices comprising optically, tuneable optical fibres and means for optical control.

It is a further object of the present invention to provide thermally, tuneable optical fibres and devices that require relatively low voltage control.

It is a further object of the present invention to provide optical fibre devices with thermal, electrical and/or optical control in the same device, giving flexible tuneable properties.

It is a further object of the present invention to provide optical fibre with fibre Bragg gratings having tuneable properties.

It is a further object of the present invention to provide a tuneable dispersion compensator based on fibre Bragg grating technology.

It is a further object of the present invention to provide Q-switched lasers.

Further objects appear from the description elsewhere.

1. “Liquid Crystal Infiltrated Photonic Bandgap Fibre”

Objects of the invention are fulfilled by an optical fibre having a longitudinal direction and a cross-section perpendicular thereto, the optical fibre comprises:
a core region; and
a micro-structured cladding region, said cladding region surrounding said core region and comprising longitudinally extending micro-structure cladding elements arranged in a background cladding material,
said micro-structured cladding elements having cross-sectional sizes which are equal or different,
at least a number of said cladding elements being arranged in a substantially two dimensional periodic manner or a Bragg-type of manner, such as concentric rings of cladding elements surrounding the core, and
said at least a number of said cladding elements are filled in at least one longitudinally extending section of the optical fibre with a liquid crystal material, and
said at least one filled section exhibits a photonic bandgap effect for at least one phase state of the liquid crystal, whereby the filled longitudinally extending section may serve as a region providing special optical properties, such as spectral filtering, polarization control or different dispersion properties compared to one or more unfilled sections of the optical fibre, or compared to a second optical fibre connected to the liquid crystal infiltrated (LCI) optical fibre. For example, the LCI optical fibre may provide transmission of light at one wavelength, λ1, and non-transmission at a second wavelength, λ2, for at least one phase of the liquid crystal. As another example the LCI optical fibre may provide one dispersion characteristic at one wavelength, λ1, and a second dispersion characteristic at a second wavelength, λ2, for at least one phase of the liquid crystal. Optical fibres guiding light by the photonic bandgap effect typically exhibit better light guidance (lower transmission loss) in a wavelength range corresponding to the bandgap compared to wavelengths outside said wavelength range (as e.g. tested by spectral measurements of transmission loss). In other words, compared to an index guiding optical fibre, a PBG-fibre typically has a larger difference in guiding properties (e.g. transmission loss) when sweeping the wavelength of light over a range of wavelengths including the wavelengths corresponding to the (or one of the) photonic bandgap of the PBG-fibre than a corresponding index guiding optical fibre.

Wherever the term liquid crystal “phase state” is used, it covers the mesophase of the liquid crystal and the molecular alignment of the liquid crystal in a specific mesophase and in a specific geometry (for example circular geometry). For example, a change in mesophase (for example caused by a change in temperature) will in most cases cause a change in molecular alignment, but a change in molecular alignment (for example caused by an applied optical or electrical field) will not necessarily cause a change in mesophase, but the phase state has changed. The phase state thereby depicts the molecular orientation of a liquid crystal in a specific mesophase, in a specific geometry, under specific surface anchoring and under specific external applied control signals (including none).

The term ‘arranged in a substantially two dimensional periodic manner’ is in the present context taken to mean that, when viewed in a cross section perpendicular to the longitudinal direction of the optical fibre, the pattern represented by the centres of the micro-structured elements is substantially repetitive when translated in each of two different directions (e.g. represented by a unit cell defined by two non-parallel vectors in the cross-sectional plane). The term ‘substantially repetitive’ is taken to mean that the centres are repetitive in the above sense but allowing for processing tolerances introduced during the manufacturing process.

The term ‘arranged in a substantially Bragg-type of manner’ is in the present context taken to mean e.g. an arrangement of cladding elements that surround the core in a substantially concentric, annular manner (e.g. in circular rings). The term ‘substantially concentric’ is to be understood as allowing for processing tolerances introduced during the manufacturing process.

The arrangement of micro-structured cladding elements may additionally comprise any other pattern of cladding elements that are NOT ‘arranged in a substantially two dimensional periodic manner’ or ‘arranged in a substantially Bragg-type of manner’.

The arrangement of micro-structured cladding elements may alternatively comprise any other pattern of cladding elements that are NOT ‘arranged in a substantially two dimensional periodic manner’ or ‘arranged in a substantially Bragg-type of manner’. In an embodiment, the arrangement of micro-structured cladding elements is substantially non-periodic, i.e. the pattern constituted by the centres of the cladding elements does not posses any symmetry or is not arranged in a substantially Bragg type manner.

The term ‘size’ is in the present context taken to be equal to ‘dimension’ or ‘area’, i.e. referring to a one- or two-dimensional extension in a given plane.

The term ‘said micro-structured cladding elements having cross-sectional sizes which are equal or different’ is in the present context taken to mean that in a given cross section, the cross-sectional dimensions (e.g. maximum dimension or area, the latter possibly including form) of the micro-structured elements are either essentially identical or different (different in the meaning that at least one micro-structured element has a dimension (e.g. a radius of a circular hole or a maximum dimension of a non-circular hole) that is different from another micro-structured element). The term ‘different’ is in the present context—when used to compare two physical parameters x1 and x2—taken to mean more different than what may be ascribed to processing tolerances for parameters that are intended to be equal OR that the numerical value of 2(x2−x1)/(x1+x2) is larger than 1%, such as larger than 5%, such as larger than 10%, such as larger than 20%.

It should be noted that the optical fibre as manufactured without LC-material introduced into a section of at least one cladding element may or may not exhibit light guidance by the PBG effect. In an embodiment, the optical fibre as manufactured without LC-material does NOT exhibit light guidance by the PBG effect at the wavelengths of its intended use.

In the present context, the ‘core region’ is defined—when viewed in a cross section perpendicular to a longitudinal direction of the fibre—as a (typically central) light-propagating part of the fibre. The core region is limited in a radial direction by micro-structural elements of the cladding region or by a cladding region having a background material with a refractive index different from the refractive index of the core region (or different from the refractive index of the background material of the core region, if the region comprises micro-structural elements).

Various examples of optical fibres exhibiting a photonic bandgap are given in the prior art section above. Photonic bandgap guidance in photonic crystal fibres (incl. material and structural prerequisites of the core and cladding regions and micro-structural elements) is also discussed in Bjarklev et al. (cf. Chapter 6, pp. 161-215).

If a change of phase state occurs for the liquid crystal, a change in the optical properties of the LCI optical fibre will occur. For example, the LCI optical fibre may provide high transmission of light at λ1 for a first phase state of the liquid crystal and lower (including none) transmission at λ1 for a second phase state. As another example, the LCI optical fibre may provide one dispersion characteristic at λ1 for one phase state and a different dispersion characteristic at λ1 for another phase state.

As another example, the LCI provide a given birefringence at λ1 for a first phase state of the liquid crystal and another birefringence at λ2 for a second phase state of the liquid crystal.

Hence, the PBG effect—and thereby the optical properties—may be tuned/controlled in the LCI optical fibre by changing the phase state of the liquid crystal.

“Micro-structured Cladding Region”

Generally, the cladding elements can be arranged in any suitable structure that provides index guiding or photonic bandgap guiding of the light of at least one wavelength, λ1, in the core region for at least one phase state of the liquid crystal material.

The size and arrangement of cladding elements can vary within broad limits.

In a preferred embodiment, at least some of the cladding elements are holes. The hole size or sizes is (are) advantageously not too small (to facilitate the introduction and/or mobility of the liquid crystal material). On the other hand, the hole size or sizes is (are) preferably not too large either to negatively influence the anchoring of the liquid crystal material. The actual optimum or acceptable hole dimensions depend on the specific liquid crystal material and the surface conditions in the holes (i.e. the material and hole size (form and or radius of curvature of the inner surfaces of the holes).

In a preferred embodiment, said cladding elements are arranged in a substantially two-dimensional periodic structure, whereby the LCI optical fibre may exhibit PBG effects in a liquid crystal filled section.

In another preferred embodiment, said cladding elements are arranged in concentric rings around said core region (Bragg-type of fibre structure), whereby the LCI optical fibre may exhibit PBG effects in a liquid crystal filled section.

Alternatively, the cladding elements may be arranged in any other pattern suitable for providing an optical fibre for guiding light, such as in a non-symmetric or non-concentric manner. Such a fibre may be characterized by index guiding of light. It is to be understood that the features discussed in the section under the heading “Liquid crystal infiltrated photonic bandgap fibre” may be combined with such a fibre.

In a preferred embodiment, substantially all cladding elements have similar ratio d/Λ (d being a maximum cross-sectional dimension of a cladding element, such as a diameter, and Λ being the minimum centre-centre distance between said cladding elements, also interchangeably termed the ‘pitch’), whereby it is obtained that an optical fibre of substantially uniform micro-structured cladding can be obtained. Such uniformity may, for example, be preferred to optimize photonic bandgap effects.

In a preferred embodiment, substantially all cladding elements have substantially equal d/Λ ratio.

Preferably, the maximum cross-sectional dimensions d of the cladding elements are substantially equal for all elements. Alternatively, they may be different, e.g. in such a way that the pattern of cladding elements—including the size and/or forms of the individual cladding elements—still possesses a two-dimensional periodicity, e.g. in that two different hole sizes (dl, d2) are positioned at two different periodic positions of the pattern.

Preferably, Λ is in the range from 1 μm to 20 μm, d in the range from 0.05 μm to 19 μm, and d/Λ is in the range from 0.05 to 0.95.

In a preferred embodiment, the ratio d/Λ of a maximum cross sectional-dimension of a cladding element to the minimum centre-centre distance between said cladding elements is in the range from 0.25 to 0.5.

In a preferred embodiment, a maximum dimension d of said cladding elements is in the range from 0.5 μm to 7 μm, such as from 1 μm to 5 μm, such as from 1 μm to 2 μm or from 3 μm to 5 μm.

Hole sizes in the range from 1 μm to 2 μm and center-to-center-distances of the holes in the range from 3 μm to 5 μm are preferred to provide first order photonic bandgap operation.

To optimize response times for optical tuning of the liquid crystal material, holes should be kept as small as possible, preferably in the range from 1 μm to 2 μm.

To optimize response times for electrical tuning of the liquid crystal material, holes can be relatively small as well as relatively large. However, losses increase for relatively large holes. Hence, an optimum hole size can be found for a specific application and material system. In a preferred embodiment, hole size is in the range from 3 μm to 5 μm.

In a preferred embodiment, the minimum centre-centre distance between said cladding elements is in the range from 1 μm to 20 μm, such as from 2 μm to 10 μm, such as from 3 μm to 5 μm.

“Materials and Additional Structures”

The LCI optical fibre comprises materials that separately are known in the art of optical fibres and liquid crystals.

The mesophases of liquid crystals and issues related to their theory, production, classification and determination of molecular alignment are described extensively in literature including the study of liquid crystal in cylindrical geometries—see e.g. P. G. de Gennes and J. Prost, J. The Physics of liquid crystals, 2nd edition, (Clarendon Press, Oxford 1993); S. Chandrasekhar, Liquid crystals, (Cambridge University Press, 1977); P. Rudquist, M. Buivydas, L. Komitov, and S. T. Lagerwall, “Linear electro-optic effect based on flexoelectricity in a cholesteric with sign change of dielectric anisotropy,” J. Appl. Phys. 76, (1994); H.-S. Kitzerow, B. Liu, F. Xu, and P. P. Crooker, “Effect on chirality on liquid crystals in capillary tubes with parallel and perpendicular anchoring,” Phys. Rev. E 54, 568-575, (1996); S. K. Lo, L. M. Galarneau, D. J. Rogers, and S. R. Flom, “Smectic Liquid Crystal Waveguides with cylindrical Geometry,” Mol. Cryst. Liq. Cryst. 201, 137-145 (1991); J. T. Mang, K. Sakamoto, and S. Kumar, “Smectic Layer Orientation in Confined Geometries,” Mol. Cryst. Liq. Cryst. 223, 133-142 (1992); or S. Kralj and S. Zumer, “Smectic-A structures in submicrometer cylindrical cavities,” Phys. Rev. E, 54(2) 1610-1617 (1996), that are incorporated herein by reference.

In a preferred embodiment, said core region, said micro-structured cladding region, or both, comprises silica whereby a well-known optical fibre material for which production techniques exists can be applied.

The optical fibre (PCF) may be filled with liquid crystal material(s) in one or more post-processing steps, where a standard commercially available PCF is purchased (supplies include Crystal Fibre A/S, Birkeroed, Denmark, for example fibres with product names LMA5, LMA8, LMA10, LMA13 and LMA15. For a specific application, a custom designed PCF may be designed and fabricated optimized to the relevant LC-materials, wavelengths, response times, etc.

The optical fibre may, however, comprise different materials for its components.

Accordingly, in a preferred embodiment, said core region, said micro-structured cladding region, or both, comprises silica and/or silica including one or more co-dopant materials, preferably a material selected from the group consisting of Ge, Al, B, or F (or other materials), or a combination thereof.

Generally, the cladding region may comprise any suitable optical fibre material, however, specific properties may be obtained by selecting specific cladding elements.

Accordingly, in a preferred embodiment, said micro-structure cladding elements are selected from the group consisting of liquid crystals.

For certain applications e.g. devices with optically tuneable optical properties, the liquid crystal can be doped with various materials in order to increase a desired optical response and/or properties of the liquid crystal. Doping materials can for example be selected from a range of azobenzene or anthraquinone dyes for example dyes with trade name Disperse red 1, Disperse blue 1, Disperse orange 1, Methyl red etc. from Sigma-Aldrich (St. Louis, Mo. 63103, USA). Other dopants may be used.

In an embodiment, the optical fibre is adapted to allow a dynamic modification of the optical properties of the fibre. Such modification or switching (the latter referring to a modification choosing one set of optical characteristics between two or more predetermined sets of optical characteristics of the fibre) may be induced by various physical effects, e.g. thermal, electrical or optical (or combinations thereof). In particular it is preferred that said cladding elements are filled with liquid crystals that may be switched between mesophases, such as for example between a smectic and a chiral nematic mesophase. Further, it is preferred that the liquid crystal can be made change molecular alignment. Preferably externally controlled means are used for switching, e.g. thermal, electrical and/or optical means.

The term ‘switched between mesophases’ is in the present context taken to mean a change of mesophase, e.g. from Chiral Smectic A to Cholesteric.

In a particular embodiment, the liquid crystal material comprises material with a positive dielectric anisotropy at frequency f1 and a negative dielectric anisotropy at frequency f2 and the means for controlling the phase state of the liquid crystal material are adapted to apply an electric field at frequencies f1 and f2, respectively. Thereby the provision of a polarization controlling component is facilitated.

It is generally preferred that the liquid crystal material is homogeneously distributed in the cladding elements in a cross section as well as over the section or sections of the fibre containing liquid crystal materials. By ‘homogeneously distributed’ is e.g. understood that the orientation of the liquid crystal material molecules is (or may be induced to be) substantially equal over the volume of the liquid crystal filled section(s). To achieve this, the liquid crystal material (and possible additives), the cross-sectional hole sizes and forms, the length of the section(s) filled with liquid crystal material, the adherence properties of the internal surfaces of the holes, etc. are adapted to each other.

For certain applications, it is advantageous to adapt the internal surfaces (e.g. their cross-sectional form, size, and/or adherence properties) of the micro-structured cladding elements to the liquid crystal material filled into them.

In a particular embodiment, the internal surfaces of at least some of the cladding elements, such as holes, at least over a part of their longitudinal extension, are coated with a layer of a material providing a specific anchoring between the liquid crystal material and the cladding background material.

In a particular embodiment, materials used for coating are selected from the group consisting of polyamides, polyimides or lipids such as phosphatidylcholine and combinations thereof.

For certain application e.g. for lasers and amplifiers, the optical fibre comprises one or more active materials for providing lasing action.

Accordingly, in a preferred embodiment, said core region and/or at least a part of said cladding background material comprises an active material, preferably silica doped with a rare earth element, most preferred silica doped with Erbium, Ytterbium, Neodymium, Holmium, Thulium, Samarium or combinations thereof.

In another embodiment, said core region and/or at least a part of said cladding background material comprises co-dopant materials, preferably a material selected from the group consisting Ge, Al, B, or F, (or other materials) or combinations thereof.

In a particular embodiment, the optical fibre further comprises a fibre Bragg grating adapted to reflect light at a wavelength λ. Thereby reflecting elements for selecting particular wavelengths may conveniently be implemented.

In a particular embodiment, the fibre Bragg grating is located in the longitudinal section of the fibre comprising liquid crystal material. Thereby a scheme for varying the optical characteristics of the fibre Bragg grating by tuning the liquid crystal material is provided.

2. “An Article Comprising an LCI Optical Fibre”

In another aspect, according to the present invention, objects of the invention are fulfilled by an article comprising a LCI optical fibre and means for controlling the phase state of the liquid crystal, whereby the optical properties of the article can be controlled/tuned.

In a preferred embodiment, the LCI optical fibre is an optical fibre according to a preferred embodiment of the present invention as described in section 1 “Liquid crystal infiltrated photonic bandgap fibre” above or an optical fibre manufactured by the method described in section 4 “Method of producing a liquid crystal infiltrated optical fibre” below, in the detailed description and figures and in the claims.

The means for controlling the phase state of the liquid crystal material may be based on one or combinations of a multitude of physical effects, including effects induced by thermal, electrical, magnetic, acoustical and optical signals.

In preferred embodiments of the invention, the control means comprise a generator for generating a physical effect (e.g. a light source, such as a laser for generating light or electrodes and connecting current generating devices for generating an electric field) and optionally any devices for coupling or facilitating the access of the signal from the generator into the optical fibre.

In preferred embodiments of the invention, the means for controlling the phase state of the liquid crystal material include means for controlling the temperature of the liquid crystal material. These means may be based on the same signal (e.g. optical) or on different signals (e.g. electrical for controlling the phase state and optical for controlling the temperature).

In a preferred embodiment, the controlling means is or comprises an optical control signal, which will be referred to as pump or pump light, whereby optical tunability is obtained. Alternatively, or additionally, the controlling means may comprise an electrical control signal. The combination of optical and electrical control may provide especially flexible solutions (e.g. in the combination of a controlled heating with the control of the phase state of the liquid crystal material).

In a preferred embodiment, the controlling means is supplied by pump light being coupled to the LCI optical fibre, the pump light having a wavelength, λp, being different than a wavelength, λs, of light being controlled/tuned in the article, whereby the signal and pump lights may be separated. For example, the pump light may be selected at a wavelength of an available laser source.

In a preferred embodiment, the pump light is coupled to the core of the LCI optical fibre, whereby a well-defined coupling can be obtained.

In a preferred embodiment, the LCI optical fibre comprises an unfilled section having cladding elements being voids/holes and a filled section having liquid crystal filled cladding elements, and said pump light being coupled to an end of said unfilled section, whereby coupling can take place at a distance away from the liquid crystal filled section, where coupling could be preferred, for example, if a coupling component or any means for connecting said end of said coupling component does not allow for liquid crystals to be in close proximity.

In a preferred embodiment, said pump light propagates in the core of said unfilled section, whereby an improved optical control or improved coupling of pump light can be obtained. For example, by selecting λp so that light at λp is guided in said unfilled region, but non-guided in said filled regions so that the power from the pump light may leak into the cladding elements comprising liquid crystal material and provide increased sensitivity, lower threshold, and/or faster tuning of the optical properties.

In a preferred embodiment, the controlling means comprise a second optical fibre being spliced to the liquid crystal infiltrated optical fibre, said second optical fibre transmitting said pump light, whereby well-defined or improved coupling can be obtained. The second optical fibre may be a micro-structured fibre or a non-micro-structured fibre.

In a preferred embodiment, the controlling means further comprises a wavelength combining optical device, such as for example a fibre coupler (also referred to as fibre WDM in literature), that combines light at λp and λs, such that relatively easy access to control and signal lights are obtained through the separate fibre ends of the fibre WDM.

The core region may comprise any suitable material including a single material, a single material doped with dopants, a mixture of materials, a mixture of materials doped with dopants, and micro-structured materials comprising liquid crystal materials. The various preferred embodiments of the present invention relating to the cladding elements may to a large extend be transferred to apply for core elements.

In an embodiment, the optical fibre comprises a first fibre Bragg grating located in the longitudinal section of the fibre comprising liquid crystal material and wherein the characteristics of said first fibre Bragg grating may be varied using the means for controlling the phase state of the liquid crystal material.

In a particular embodiment, the variation in characteristics of the first fibre Bragg grating is used to implement a tuneable dispersion compensation module.

In a particular embodiment, the optical fibre comprises a further fibre Bragg grating adapted to reflect a wavelength λ1 and wherein the characteristics of said first fibre Bragg grating are adapted to reflect a wavelength λ1 for a specific time interval Δt. Thereby a Q-switched laser can be made, where the cavity formed from the two FBGs when they are reflecting at wavelength, λ1, is only present in the time interval Δt (Δt e.g. being a tuneable fraction of a repetitive time period).

In a particular embodiment, the means for controlling the phase state of the liquid crystal material comprise a resulting electric field defining an angle with a longitudinal direction of the optical fibre that is different from 90°, such as a few degrees different, such as one or 2 degrees different. Thereby the formation of defects formed by reverse tilt domains in the liquid crystal material can be minimized or avoided.

In a particular embodiment, the liquid crystal material comprises material with a positive dielectric anisotropy at frequency f1 and a negative dielectric anisotropy at frequency f2 and said means for controlling the phase state of the liquid crystal material are adapted to apply an electric field at frequencies f1 and f2, respectively. Thereby the provision of a polarization controlling component can be facilitated.

3. “Predetermined Wavelength”

In a particular application, the optical fibre used depends on the required wavelength or range of wavelength of operation. An operating wavelength shall be referred to as a signal wavelength, λs (and signal light for light at the operating wavelength).

In a preferred embodiment, λs is in the range from 0.1 μm to 2.0 μm. Specifically, in the range from 0.4 μm to 1.7 μm, preferably in the range from 1.3 μm to 1.7 μm, most preferred in the range from 1.5 μm to 1.6 μm whereby the optical fibre may be used for applications using visible to near-infrared light.

4. “Method of Producing a Liquid Crystal Infiltrated Optical Fibre”

In another aspect, according to the present invention, there is provided a method of preparing an LCI optical fibre having a longitudinal direction and a cross section perpendicular thereto, the method comprising:

providing a micro-structured optical fibre having a core region and a cladding region surrounding the core region, the cladding region comprising holes/voids in the cladding with a predetermined arrangement and size;

providing a liquid crystal material that is capable of being in different phase states; and

introducing said liquid crystal material into at least a part of said number of holes/voids over at least one longitudinal section of the optical fibre,

whereby the optical properties of the LCI optical fibre may be tuned/controlled.

In a particular embodiment, said predetermined arrangement and size of holes/voids, and liquid crystal material being selected to provide photonic bandgap effects over the at least one longitudinal section of the optical fibre. This can e.g. be achieved by arranging that at least a number of said cladding elements are arranged in a substantially two dimensional periodic manner or a Bragg-type of manner, such as concentric rings of cladding elements surrounding the core region. Alternatively, the cladding elements may be arranged in any other pattern suitable for providing an optical fibre for guiding light (by index guiding or the PBG-effect), such as in a non-symmetric or non-concentric manner.

In a particular embodiment, it is arranged that said liquid crystal material comprises a component, e.g. in the form of an additive, that is suitable for or selected to provide the possibility of externally controlling/modifying the temperature of the liquid crystal material and thereby its optical properties. The modification may e.g. be induced by an external electrical or optical signal. In a particular embodiment, the component or additive is a dye that absorbs light at particular wavelengths thereby heating the liquid crystal material and changing its optical properties. The light may be entered from an end of the optical fibre or from the side.

In a particular embodiment, the micro-structured optical fibre of step (a) is an optical fibre according to the invention as described in section 1 “Liquid crystal infiltrated photonic bandgap fibre” above, in the detailed description and figures and in the claims.

5. “Method of Producing an Optically Tuneable Article Comprising a Liquid Crystal Infiltrated Optical Fibre”

In another aspect, according to the present invention, there is provided a method of preparing an optically tuneable article according to the invention as described in section 2 “An article comprising an LCI optical fibre” above, in the detailed description and figures and in the claims, the method comprising:

providing a LCI optical fibre;

connecting one end of a second optical fibre or a fibre WDM component or another optical component by but-coupling, free-space coupling or splicing to said LCI optical fibre.

6. “Use of the Optical Fibre”

In another aspect, according to the present invention, there is provided use of a LCI optical fibre according to the present invention or a LCI optical fibre produced in a method according to the invention in an optical switch, an optical polarization controller, an optical birefringent element, an optical compensator for polarization-mode dispersion, an optical filter, an optical communication system, in an optical fibre laser such as a Q-switched laser, or in an optical fibre amplifier, or in one or more parts thereof.

7. “Use of the Tuneable Optical Article According”

In another aspect, according to the present invention, there is provided use of a tuneable optical article according to the present invention or an optical article produced in a method according to the invention in an optical switch, an optical polarization controller, an optical birefringent element, an optical compensator for polarization-mode dispersion, an optical filter, an optical communication system, in an optical fibre laser such as a Q-switched laser, or in an optical fibre amplifier, or in one or more parts thereof.

Definition of Expressions

In the present context it is intended that the term “light” designates electromagnetic radiation, in particular light having a wavelength in the range from 0.1 μm to 30 μm.

The term “from a to b” is intended to mean the range from a to b including a and b.

The term “substantially” is intended to mean being largely but not necessary wholly that which is specified.

The terms “optical fibre”, “micro-structured fibre”, “holey fibre”, “hole assisted fibre”, “PCF” and “PBG fibre” are in this application often used interchangeably for optical fibres that comprise cladding elements that may be filled with liquid crystal.

For definitions and terms related to fibres comprising micro-structured cladding elements, see afore-mentioned Bjarklev et al. reference.

### BRIEF DESCRIPTION OF THE DRAWINGS

In the following, by way of examples only, the invention is further disclosed with detailed description of preferred embodiments. Reference is made to the drawings in which

FIG. 1 shows schematically an example of a LCI PCF according to an embodiment of the present invention.

FIG. 2 shows a microscope photograph of a PCF before filling of liquid crystals in the holes/voids.

FIG. 3 shows schematically a setup for filling or infiltrating the PCF with liquid crystals.

FIGS. 4a, 4b show microscope photographs of a LCI PCF after filling of liquid crystals in the holes/voids.

FIG. 5 shows a microscope photograph of another LCI PCF after filling of liquid crystals in the holes/voids.

FIG. 6 shows experimentally observed near-field distributions of the fundamental mode of the fibre in FIG. 1 after filling the holes/voids with a liquid crystal.

FIG. 7 shows schematically liquid crystal phase states.

FIG. 8 shows schematically other liquid crystal phase states.

FIG. 9 Simulation of PBG effect from cladding structure of a LCI optical fibre with liquid crystals in isotropic phase.

FIG. 10 Simulation of PBG effect from cladding structure of a LCI optical fibre with liquid crystals in anisotropic state.

FIG. 11 shows schematically a device comprising a LCI PCF and providing thermal control of the LCI PCF.

FIG. 12 shows spectral characteristics of a device comprising a LCI PCF.

FIG. 13 shows spectral characteristics of a device comprising a LCI PCF.

FIG. 14 shows the spectral characteristics of a device comprising a LCI PCF measured immediately after filling the optical fibre with liquid crystals and 5 weeks thereafter.

FIG. 15 shows spectral characteristics of a device comprising a LCI PCF used for switching.

FIG. 16 shows measured extinction ratios for devices comprising optical fibres with different lengths of LCI sections.

FIG. 17 shows spectral characteristics of a device comprising a LCI PCF.

FIG. 18 shows schematically a device comprising a LCI PCF. The properties of the LCI PCF may be optically controlled.

FIG. 19 shows a simulation of the PBG effect and confined modes for a full LCI fibre with liquid crystals in isotropic phase.

FIG. 20 is an illustration of a simulated core mode at wavelength As (top) and simulated cladding modes at wavelength λp (bottom).

FIG. 21 schematically shows a device comprising a LCI PCF comprising fibre Bragg gratings (FBG) (top figure). The properties of at least one FBG may be tuned using a LCI filled section. The tuning may, for example, provide different reflection wavelength that can be controlled on a time scale (as shown schematically in the lower part of the figure).

FIG. 22 shows a schematic configuration for electrical control of fibre properties according to an embodiment of the invention.

FIG. 23 illustrates the function of an article according to the invention, FIG. 23a schematically showing an LCPCF according to the invention in a laser configuration and FIG. 23b showing a corresponding transmission spectrum.

FIG. 24 shows an exemplary setup for the testing of optical tuning properties of a laser according to the invention (FIG. 24c) and exemplary pump modulation signals (FIGS. 24a and FIG. 24b showing 100 Hz and 1 kHz modulation, respectively).

### DETAILED DESCRIPTION OF THE PREFERRED EMBODIMENTS

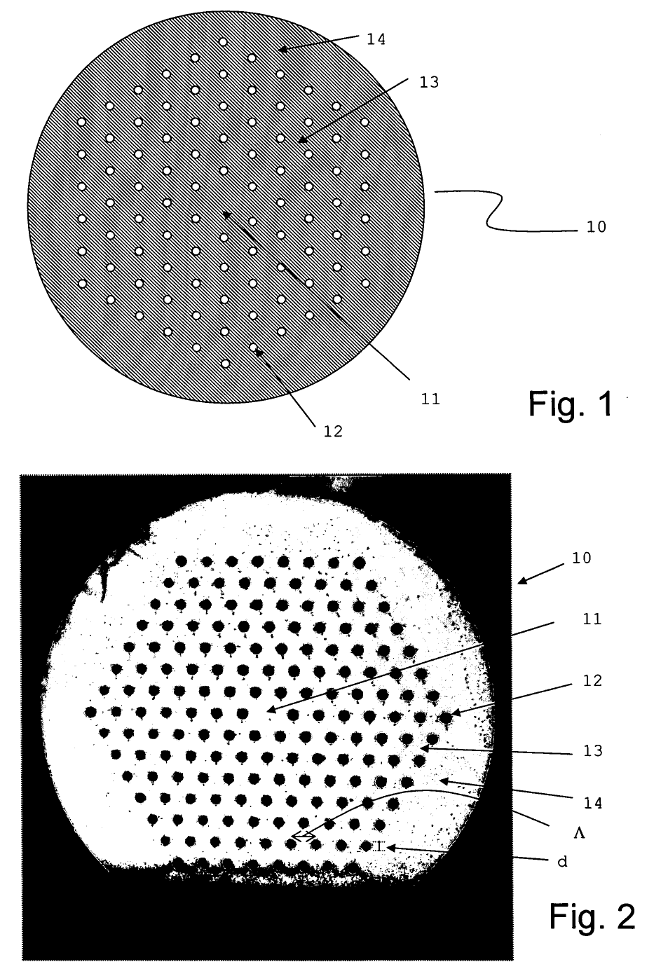

FIG. 1 schematically depicts the cross-section of an exemplary preferred embodiment of an optical fibre 10 according to the present invention. The optical fibre comprises a core region 11, a micro-structured cladding region surrounding said core region and comprising micro-structured cladding elements 12, or so-called cladding elements 12, at least a part of the cladding elements being filled with liquid crystal material(s). The cladding elements are here of equal size d, but variations may occur due to design and/or production variations. The cladding elements are placed in a background cladding material 13, and an over-cladding region 14.

In this example, the cladding elements surround the core region and define a substantially two-dimensional periodic lattice in the cross-section of the fibre. In the longitudinal direction of the fibre, at least a section of the optical fibre comprises cladding elements that are filled with liquid crystals. The liquid crystals may be in isotropic phase or exhibit a specific mesophase, for example nematic, smectic a, smetic c, smectic c*, and/or cholesteric.

FIG. 2 shows a microscope photograph of the cross-section of an optical fibre comprising holes 12 that may be filled with liquid crystals. The optical fibre 10 has a core region 11 of similar material as the cladding background material 13—in this case pure silica. The optical fibre has a centre-to-centre cladding element spacing, the so-called pitch, Λ, of about 7 μm and a cladding element size, here hole diameter, d, of about 3 to 4 μm. Preferably, Λ is in the range from 1 to 20 μm, d in the range from 0.05 to 19 μm, and d/Λ is in the range from 0.05 to 0.95.

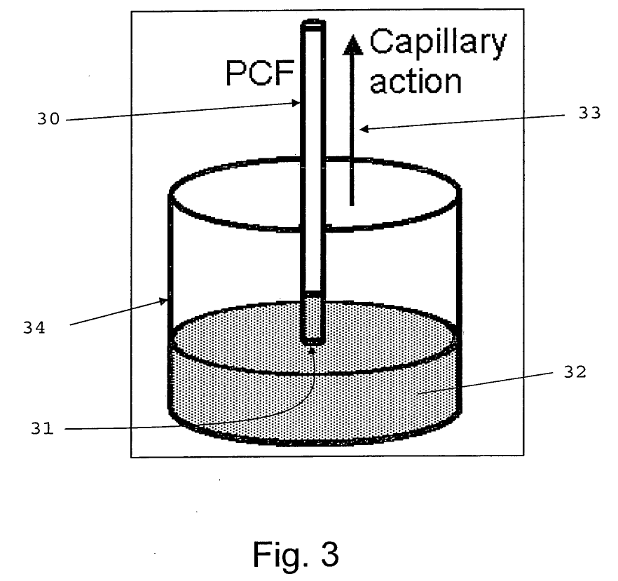

The optical fibre may be filled with a desired liquid crystal by a setup comprising a container 34 holding the liquid crystal material 32, as for example shown schematically in FIG. 3. One end 31 of the PCF 30 is placed in contact with the liquid crystal materials 32, and capillary effects (indicated by arrow 33) cause the liquid crystals to infiltrate the PCF. Optionally, vacuum, pressure, temperature or other means may be employed to aid the infiltration.

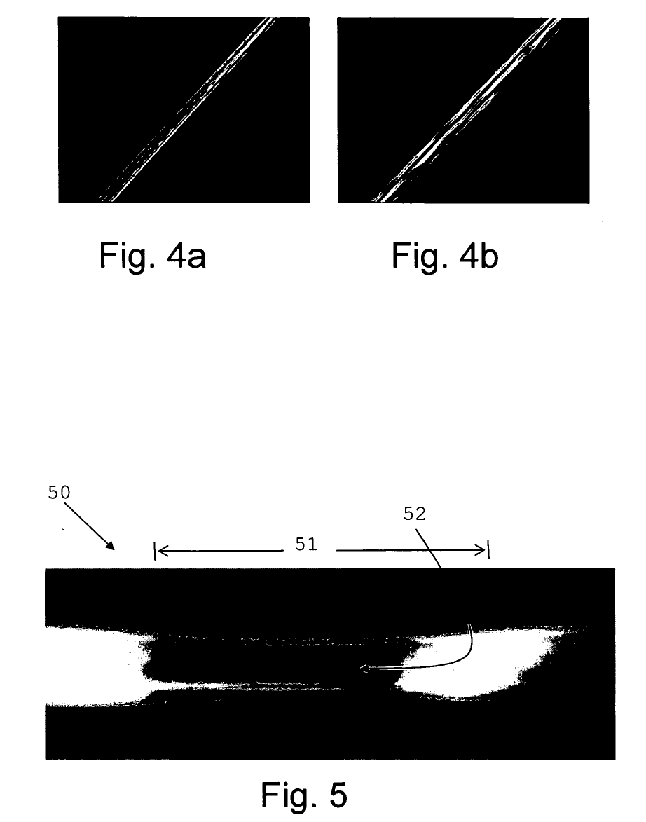

To aid the control of the alignment of the liquid crystal, the surface of the PCF holes can be coated with a thin layer of a material providing a specific anchoring between the liquid crystal and the PCF material i.e. planar, homeotropic or tilted alignment. For example, materials used for coating could be polyamides, polyimides or lipids like phosphatidylcholine. These materials could be dissolved in an appropriate solvent e.g. ionised water. The emulsion could be pressed through the holes of the PCF by the use of high-pressure or/and vacuum. Pressing the emulsion through the holes, will leave a small residue on the surface of the PCF holes, giving surface anchoring to the liquid crystal. The surface coating should be done before infiltration with liquid crystal. FIG. 4 shows an example of a coating material (phosphatidylcholine), which favours homeotropic alignment of the liquid crystal. FIG. 4a and 4b shows examples of polarized micrographs of silica capillaries filled with nematic liquid crystal E7 from Merck. FIG. 4a illustrates planar alignment of liquid crystals in uncoated capillaries, whereas FIG. 4b illustrates ‘Escaped radial’ alignment (cf. also the schematic cross section of FIG. 8) in a homeotropic coated capillary. The coating material is here phosphatidylcholine (also called Lecithin) dissolved in ionised water.

In an embodiment, the PCF (before introducing the LC-material) is a so-called hollow core PCF, airguide PCF, or airguide PBG fibre. The liquid crystal material is placed inside the (large) hole that forms the core. The colouring on microscope pictures of such LCI PCFs taken with polarized light appears as a result of the alignment of the liquid crystal molecules and may be used to determine this alignment and the phase state of the liquid crystals. In an embodiment, the mesophase is nematic aligned in a so-called “escaped radial” formation.

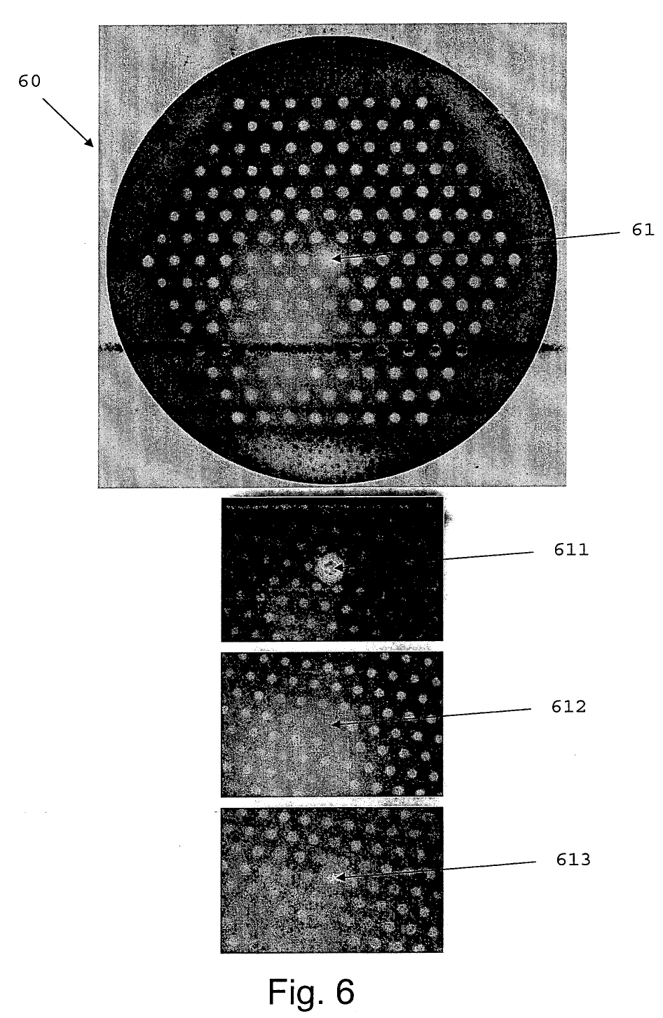

FIG. 5 shows another microscope picture of a LCI PCF. The PCF in this example is also a hollow core PCF. The fibre has cladding holes that have been collapsed in a section 51 of the fibre—leaving a hollow core and a solid silica cladding. This technique was used to provide better viewing of the liquid crystals in the core (to provide improved possibility of determining the phase state). The collapse of the cladding holes was performed using a fusion splicer for standard optical fibres. The LCI PCF is illuminated with white light, and blue light 52 is seen to be reflected. Again this indicates how the liquid crystal molecules are oriented inside the hole. The liquid crystal has a helical axis that is perpendicular to the hole-surface and the longitudinal direction of the fibre.

FIG. 6 shows experimentally observed near-field distributions of the fundamental mode of the fibre in FIG. 2 after filling a longitudinal section of around 20 mm of the cladding holes with a liquid crystal with the trade name MDA-00-1445 from Merck KGaA, Darmstadt, Germany. The fibre 60 is illuminated with white light from one end, and the near-fields are recorded at the other end of the fibre. The top microscope picture shows the full cross-section of the fibre, whereas the lower pictures show only core 61 and inner part of the cladding 62 for reasons of clarity. The pictures show the PCF heated to temperatures of around 77, 89, 91, and 94° C., respectively, going from top picture to bottom picture. The near fields demonstrate strong spectral filtering, as illustrated by the light in the core appearing green (61), yellow (611), black (612) and blue (613), respectively from top to bottom. The filtering is caused by photonic bandgap effects. The spectral properties of the fibre are strongly dependent on the temperature, hence the optical properties of the fibre may be (thermally) tuned. The spectral position is determined by the PCF design (core and background materials, cladding element sizes and geometrical arrangement), and specific liquid crystal type and liquid crystal phase state. Having chosen a PCF and the liquid crystal material (most of the parameters for the LCI optical fibre or device now being locked), the phase states and refractive indices (through thermal tuning) are available for tuning the optical properties of the LCI optical fibre or device. It is preferred that the parameter choice is made such that the PCF may exhibit PBG effects at least at one wavelength, λs, where the fibre or fibre device should operate. The strong spectral selectivity of the PBG effect enables sensitive control/tuning.

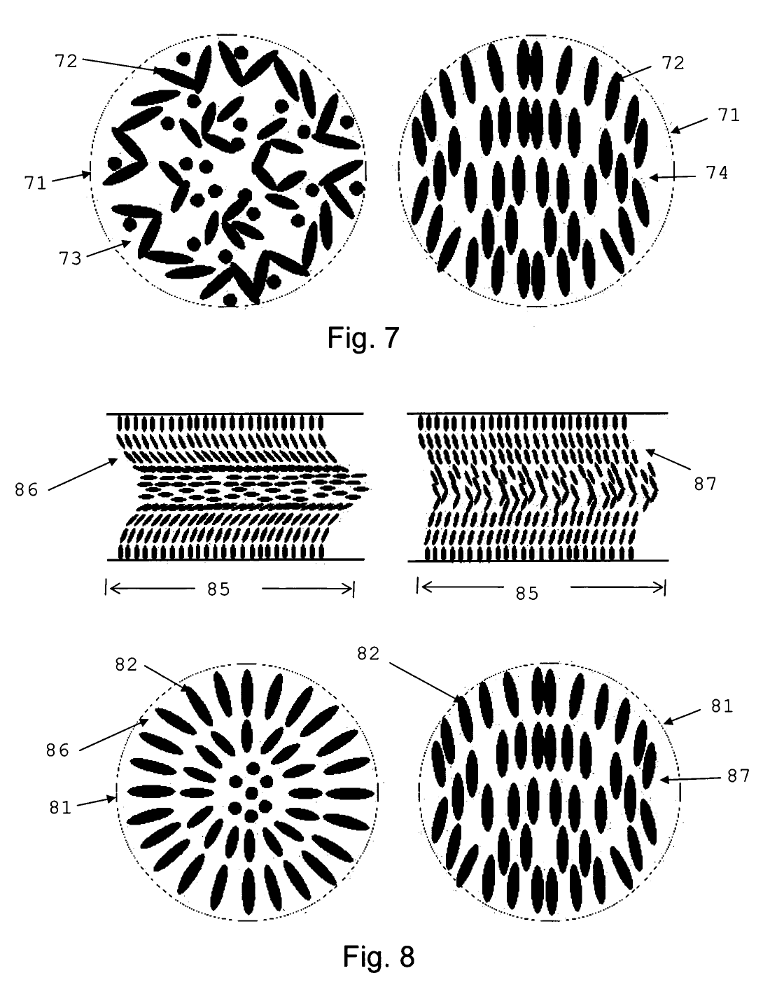

Examples of the various phase states of liquid crystals are shown in FIG. 7 and FIG. 8. FIG. 7 shows schematically a cross section 71 of a circular element being filled with a liquid crystal in an isotropic state 73 (left), and in an anisotropic state 74 (right). Change from an isotropic state to an anisotropic state may take place by applying an optical/electrical field. The liquid crystal molecules 72 will orient themselves according to the applied field (the ordering in this figure may be exaggerated for reasons of clarity).

FIG. 8 shows schematically a longitudinal section 85 (two top figures) and cross section 81 (two bottom figures) of a circular element (such as a micro-structural element (e.g. a hole) of an optical fibre according to the invention) being filled with a liquid crystal, where the liquid crystal molecules 82 are oriented in a so-called “escaped-radial” formation 86 in a nematic mesophase (left figures), and an anisotropic phase state 87 where an optical/electrical field is applied (right figures).

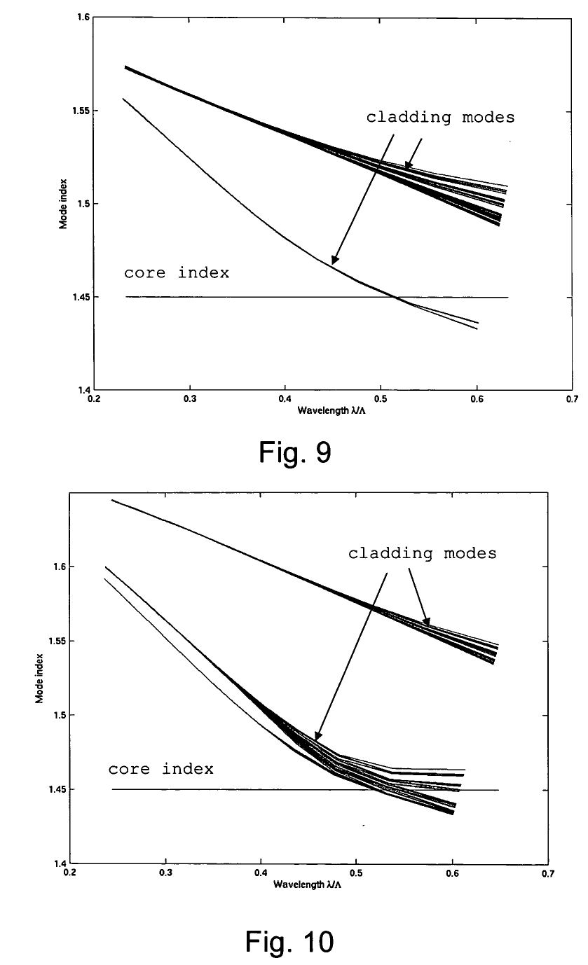

FIG. 9 and 10 serve to provide insight into the principle behind the tuneable properties of the LCI optical fibres that may exhibit PBG effect for at least one phase state. The figures show the principle of changing PBG effects in the optical fibres by changes in phase state of the liquid crystals.

FIG. 9 shows a simulation of the cladding structure of a PCF with cladding elements being filled with a liquid crystal material over a longitudinal section of the optical fibre, where the refractive index of the cladding elements comprising liquid crystal material is approximated by an isotropic, effective refractive index value of 1.59. This is used to simulate the cladding structure in an isotropic state. The simulation is performed for circular cladding elements placed in a so-called close-packed or triangular arrangement. The cladding elements have diameter, d, and have a centre-to-centre spacing, Λ. The numerical method used for the simulation is described by S. G. Johnson and J. D. Joannopoulos, “Block-iterative frequency-domain methods for Maxwell's equations in a planewave basis,” Opt. Express 8, 173-190 (2001). The background material of the core and the cladding is assumed similar and a refractive index value of 1.45 is used (representative to silica). The simulation shows allowed modes of the cladding structure and reveals that no modes are allowed with mode index around that of the core (having an index of typically 1.45 for silica, as indicated by the horizontal line on FIG. 9) for normalized wavelengths, λ/Λ, larger than around 0.5 (as far as the figure shows). Hence, the cladding exhibits PBG effect that may provide confinement to the core region, see e.g. afore-mentioned Bjarklev et al. reference (chapter 6, pp. 161-215) or Broeng et al. WO 02/101429 for further details on the PBG effect. FIG. 10 shows a similar type of simulation, but for the cladding filled with liquid crystal in an anisotropic state, where we assume anisotropic refractive index with ne=1.69 and n0=1.50 (the afore-mentioned numerical method may also be employed for anisotropic media, and the terms ne and no refer to parameter-labelling used for this). As seen from FIG. 10, no PBG effect is exhibited that may provide confinement to the core region for normalized wavelengths, λ/Λ, larger than around 0.5. On the other hand, there are a number of allowed modes in the cladding for mode indices around 1.45 at these wavelengths; this will cause light that for example is coupled to the core to leak to the cladding (causing reduction or total loss in transmission). The principle demonstrated using FIG. 9 and 10, may for example be used to provide a switching device. As an example, for operation at a normalized wavelength, λ/Λ, around 0.6, the LCI optical fibre may be used in an on-off switch by changing the phase state of the liquid crystals from isotropic to anisotropic.

Apart from on-off behaviour, it is also within the present invention to provide LCI optical fibres, where the optical fibre transmits light at a given wavelength in two different phase states, but the waveguiding properties, such as for example dispersion is changed. In this way optical fibre and fibre devices with tuneable optical properties may be provided. Optical fibres that exhibit PBG effects are known to have strongly dispersive properties, the dispersion characteristic being strongly dependent on the spectral position of the PBG transmission bands. Hence, by changing/tuning/controlling the PBG transmission bands in LCI optical fibres, an optical fibre or device with tuneable dispersion properties can be made.

Thermal Tuning:

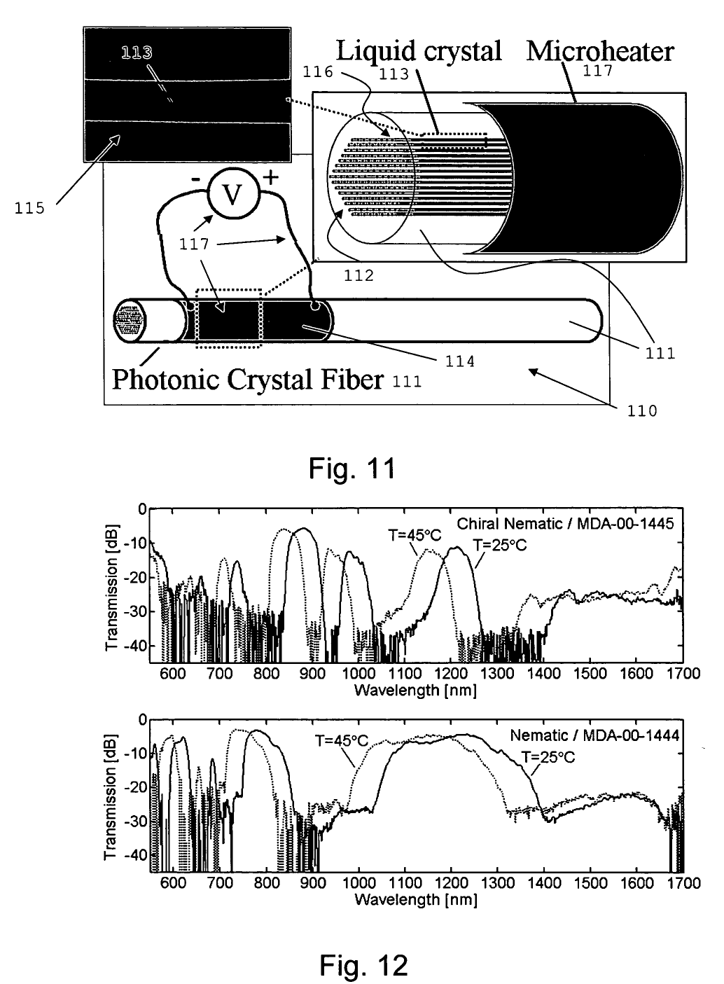

FIG. 11 shows schematically a device 110 comprising a LCI optical fibre 111 that may be used as a tuneable device. The right inserts shows the LCI optical fibre comprising a pattern of longitudinally extending holes 112, where the holes are filled with liquid crystal material 113 over a longitudinal section of the fibre's length. An electrically resistive foil (e.g. a metallic layer) 114 is applied to at least a part of the surface of the section of the LCI optical fibre containing liquid crystal material. The top left insert shows a part 115 of the liquid crystal containing section of a single hole 116 of the LCI optical fibre. The tuning is here controlled thermally by heating the fibre using a resistive micro heater 117, here in the form a thin conductive layer 114 on the surface of the optical fibre subject to an electric voltage difference over at least a part of its physical extension.

FIG. 12 shows spectral characteristics from λ=500 nm to 1700 nm of devices comprising a PCF infiltrated with MDA-00-1445 liquid crystal (top) and MDA-00-1444 liquid crystal (bottom) from Merck, Darmstadt, Germany. The spectra of top and bottom figures are taken at T=25° C. as well as at T=45° C. This device may provide tuneable optical properties for a range of wavelengths. For telecom applications, it may be preferred, for example, to use the device at a wavelength of 1300 nm where a significant change in transmission can be introduced by temperature control (see lower FIG. 12).

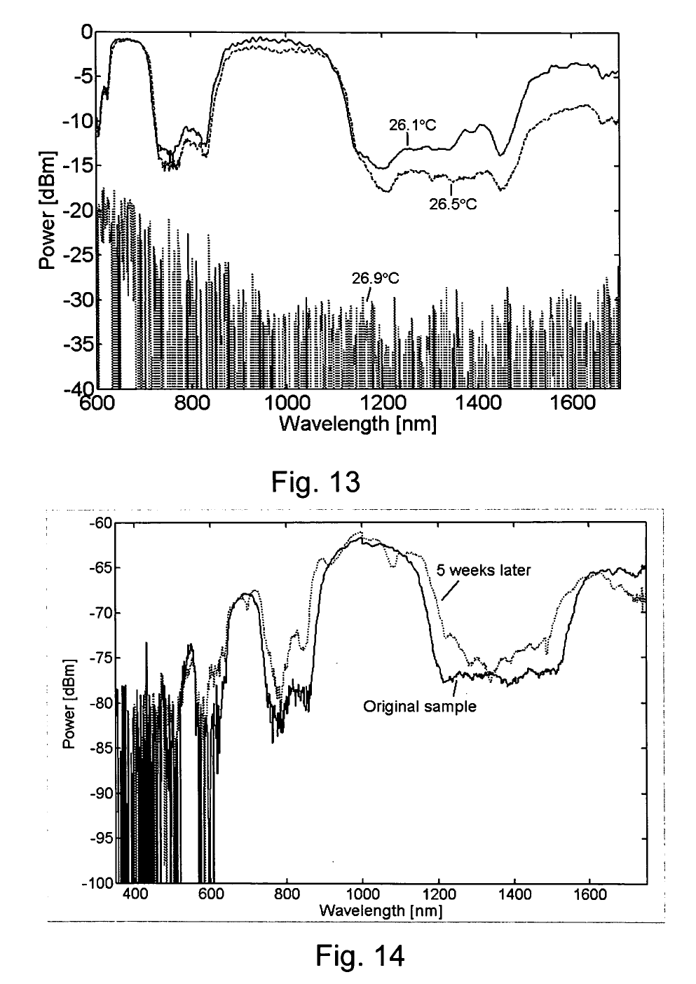

FIG. 13 shows spectral characteristics from λ=600 nm to 1700 nm at T=26.1° C., at T=26.5° C. and at T=26.9° C. of a device comprising a PCF infiltrated with a liquid crystal of trade mark TM216 from BDH, Poole, United Kingdom, over a section of length of 10 mm of the optical fibre. The characteristics were measured by coupling white light to one end of the fibre and detecting the transmitted light in an optical spectrum analyzer. The device provides tuneable optical properties for a range of wavelengths. The device is further characterized by very sensitive tuning—only temperature changes of less than 1° C. (and even less than 0.4° C., cf. FIG. 13) are required to provide strong changes in the optical properties of the fibres. This may be translated into low driving voltages for the control of the device—here on the order of 5 mV. For this low driving voltage range (or temperature range), phase transitions from chiral smectic A(SmA*) to chiral nematic(N*) may take place. In these two phases, the LC is ordered and disordered, respectively, giving rise to non-scattering and scattering properties of the LC. In the case of LC showing scattering properties, the losses may be significantly higher than in the non-scattering case. Insertion loss for the device when operated in the SmA* state (where the LCI optical fibre exhibits PBG transmission bands for wavelengths of around 650 nm to 700 nm and around 900 n to 1100 nm) was found to be as low as 1 dB.

FIG. 14 shows the spectral characteristics from λ=400 nm to 1700 nm of the device of FIG. 13 measured immediately after filling the fibre with liquid crystal material and 5 weeks thereafter. The figure shows some deviation between the two measurements. However, it is expected that better agreement and indeed good long term stability of the device can be obtained by careful handling and keeping.

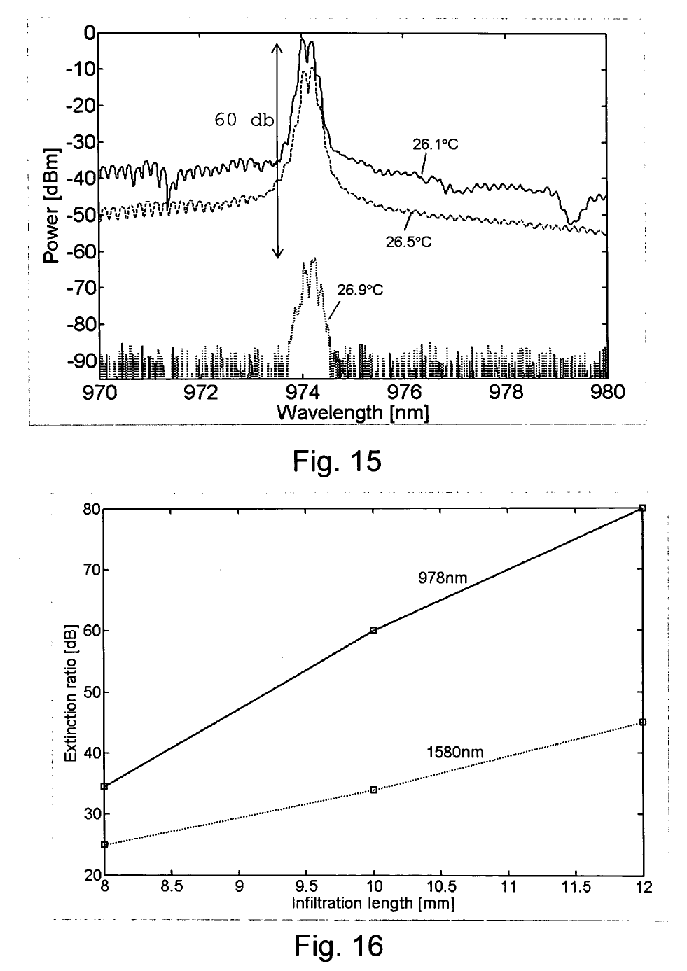

FIG. 15 shows spectral characteristics from λ=970 nm to 980 nm of the device of FIG. 13 when coupling laser light with a wavelength of 974 nm into the LCI fibre. The figure shows an extinction ratio as high as 60 dB for the device operated as a switch, as indicated by the difference in transmission levels around the lasing wavelength (cf. arrow in FIG. 15).

FIG. 16 shows measured extinction ratios for the device of FIG. 13 for different lengths of LCI sections measured at 978 nm and 1580 nm, respectively. The extinction ratio may be increased by increasing the filled section length. Extinction ratios of more than 40 dB may be obtained at wavelengths around 1.5 μm for a filled section of length around 12 mm. Extinction ratios as high as 80 dB may be found for filled sections of length 12 mm at a wavelength of 976 nm.

LCI optical fibres and devices according to various preferred embodiments of the present invention may be used for Q-switched fibre lasers, where a change in phase state can switch the fibre laser properties.

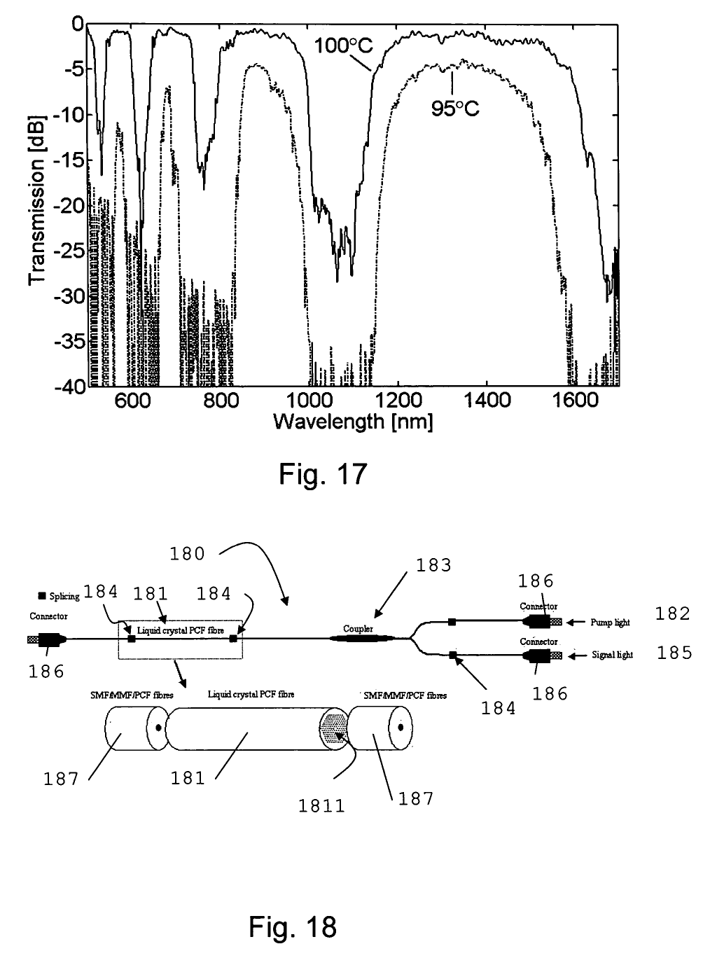

FIG. 17 shows spectral characteristics from λ=500 nm to 1700 nm at 95° C. and 100° C., respectively, of another device comprising a PCF infiltrated with a liquid crystal. The liquid crystal is in this example MDA-00-1445, and the fibre is that of FIG. 2. The operation is around the isotropic phase.

Optical Tuning:

FIG. 18 shows schematically a device 180 comprising a LCI PCF 181. The properties of the LCI PCF may be optically controlled. In this example, the optical control is provided using a pump light 182 being coupled to one 1811 end of the LCI fibre 181 using a fibre coupler 183. Pump light may be coupled to the LCI fibre using fibre splice 184, but-coupling, collimators, bulk optics, side coupling or illumination, or other means. Signal light 185 may coupled to the LCI fibre in a like manner via connector 186 and fibre coupler 183. The fibre coupler 183 may be based on a single mode or multimode standard fibre or a photonic crystal fibre 187. Light may be coupled out of the device via an optical fibre 188 (e.g. as shown via an optical connector 186) optically coupled to the LCI fibre. There is a range of advantages that can be obtained by optically controlled/tuned properties. These include fast tuning (hereby is generally also understood switching), more practical solutions (thermal control is typically more impractical requiring manufacturing and assembling of features for heating, as well as the resulting devices being relatively slow), and development of ‘intelligent’ optical systems. The latter, for example, being an optical system, where one optical signal provides feedback to control another signal. This could, for example, be used for trimming/tuning of optical properties such as dispersion or dispersion slope in dispersion compensating modules. As another example, this could be used for tuning/trimming filtering characteristics in an optical amplifier or laser system. As another example, in very advanced versions this could lead to optical signal processing.

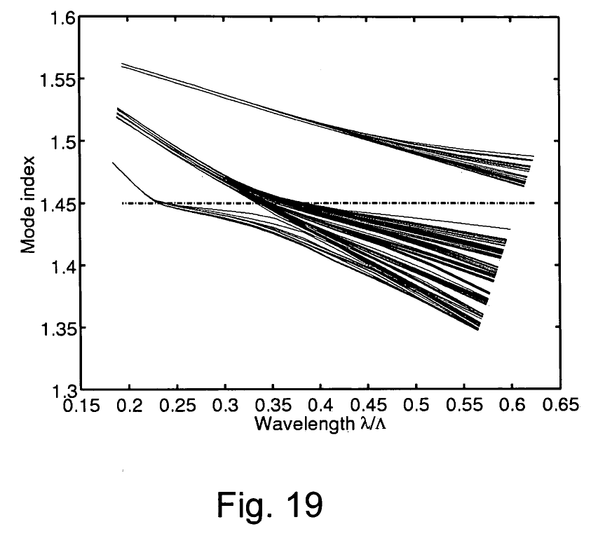

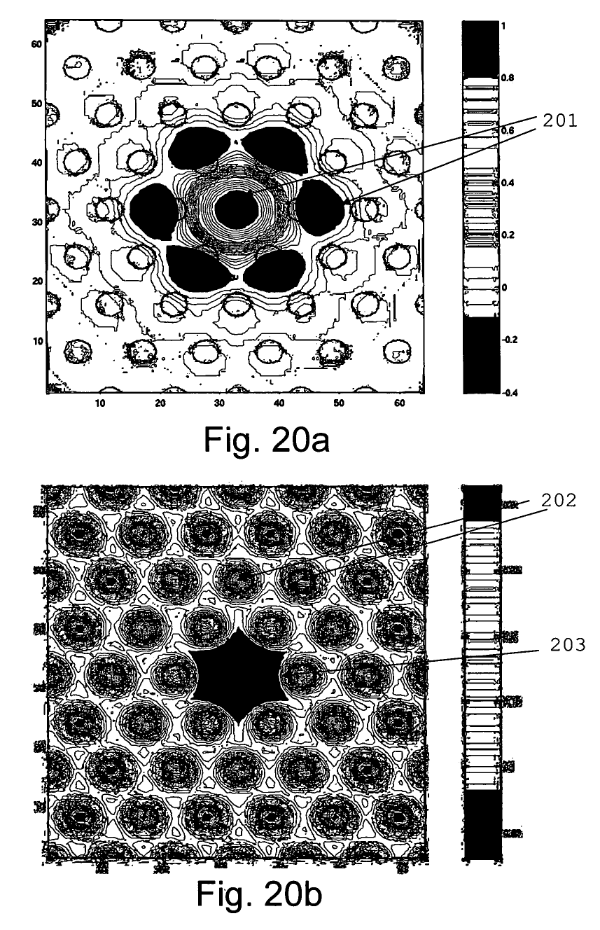

FIG. 19 and 20 illustrates the principles of providing optical power to influence the liquid crystals. FIG. 19 shows a simulation similar to that of FIG. 9, but in this simulation the LCI optical fibre is simulated including the core region. Hence, the FIG. 19 shows both core modes and cladding modes.

FIG. 20 illustrates a core mode 201 at wavelength λs (FIG. 20a) and simulated cladding modes 202 at wavelength λp (FIG. 20b). λp being for example a wavelength, where no core modes are supported (for example \tilde{□}□=0.40), and λs naturally being a wavelength where a core mode is supported (for example λ/Λ=0.55). The core mode is confined to the core and may be guided through the fibre. The cladding modes are not guided by the core (cf. 203 in FIG. 20b). Therefore, light at wavelength λp that for example is coupled to the core of the LCI fibre (for example using a setup as schematically in FIG. 18) will quickly leak into the cladding. As seen there is a large overlap for the cladding modes with the cladding elements (hence with the liquid crystal material). Thereby, the pump light couple to cladding modes and provide optical access to the liquid crystals—and consequently provide means for changing the phase state of the liquid crystals and tuning the optical properties of the fibre. This may, for example, be done by adjusting/controlling/tuning the optical power at wavelength λp and/or adjusting the modulation frequency of the light at wavelength λp.

Optical and Thermal Tuning:

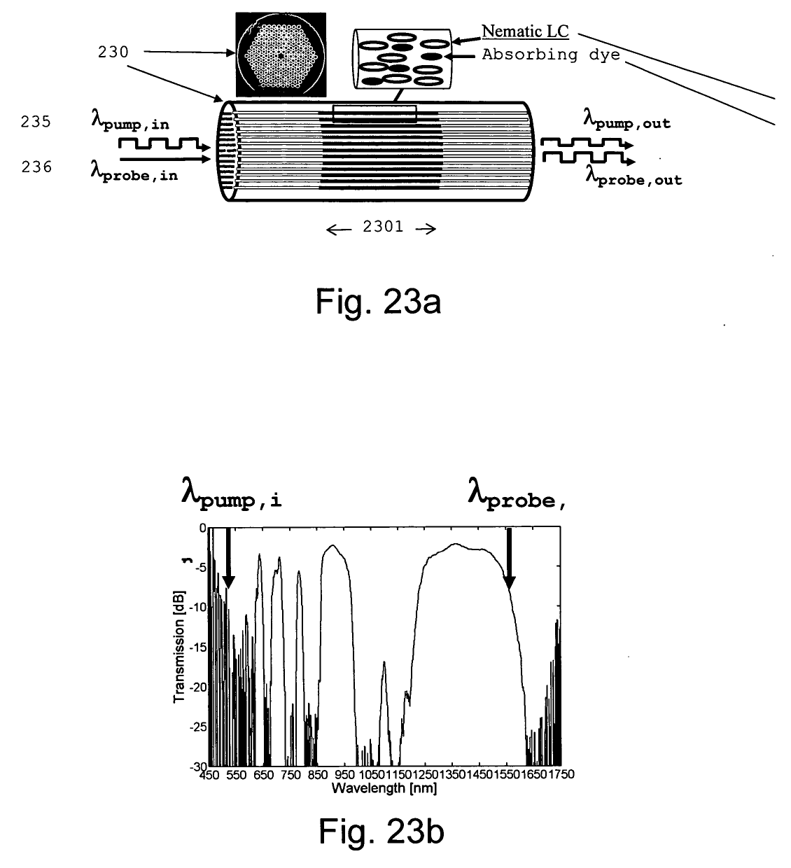

Further, the liquid crystal 231 can be doped with an appropriate dye 232, which absorbs at wavelength λp, and, in this way, heat the LC, which changes its refractive index. This changes the bandgaps of the fibre and, thereby, also the transmission properties of the fibre. FIG. 23 illustrates the device principle for optical tuning (FIG. 23a) and the figure also shows an experimentally obtained transmission spectrum from a dye doped nematic liquid crystal PCF (Dye: Disperse Red 1, LC: E7) (FIG. 23b). FIG. 23a illustrates how a pump laser 235 with wavelength λpump and a probe laser 236, with wavelength λprobe, can be coupled into a LCI-PCF 230 filled with a dye doped nematic liquid crystal material over a longitudinal section 2301 of its length. The LC and PCF parameters are chosen in such a way, that a guided mode is present at the probe wavelength but not at the pump wavelength. The pump, therefore, couples more efficiently to the cladding and is absorbed by the dye 232, which is heated. The heating shifts the band gap at the probe wavelength, and the probe laser is, therefore, modulated. FIG. 23b shows a transmission spectrum between 450 nm and 1750 nm of a LCPCF fibre device, where the liquid crystal material was nematic E7 (Merck, Darmstadt, Germany) doped with Disperse Red 1 (Sigma Aldrich). Pump laser wavelength λpump and probe laser wavelength λprobe are indicated.

For devices utilizing optical induced heating, two operating regimes are identified: a non-local and a local regime. In these two regimes, the dynamic response can vary with more than one order of magnitude, when the light at wavelength λp is amplitude modulated.

In the local regime, where the duration of the pulse is shorter than the thermal diffusion time of the LC infiltrated rod, the silica structure surrounding the LC acts as a thermal reservoir, which absorbs the thermal energy from the LC as soon as the light is switched off. The thermal energy of the LC rods is, therefore, transferred to the silica very quickly and the LC is cooled down. In this regime, of 100 μs have been experimentally obtained.

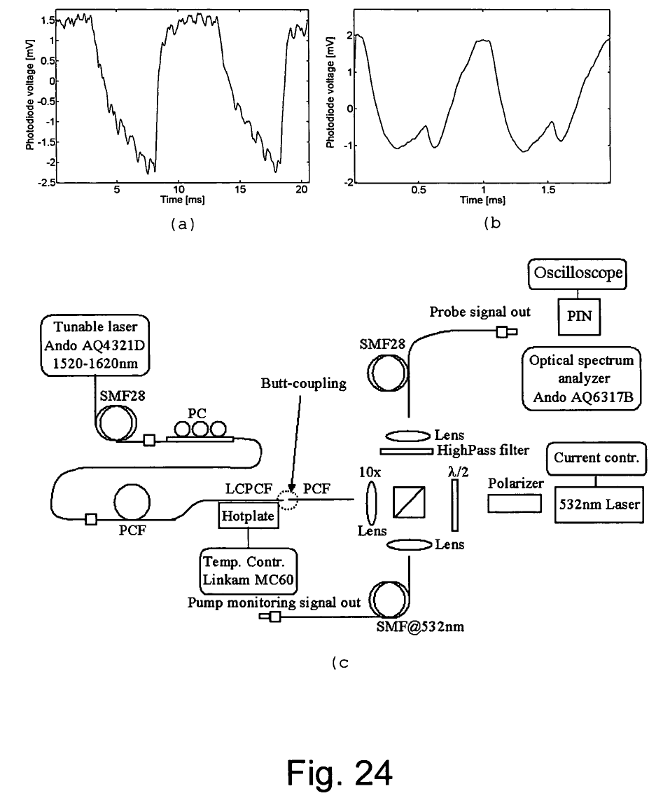

In the non-local regime, where the duration of the pulse is longer than the thermal diffusion time of the LC infiltrated rod, the thermal energy of the LC rod diffuses into the silica and also heats the silica structure before the light pulse is switched off. When the light pulse is switched off, both the silica and the LC have to cool down, and this slows down the dynamic response of the device. In this regime a response time on the order of 3 ms have been experimentally obtained. This is shown on FIG. 24, which shows oscilloscope traces of the modulated light at wavelength λs (FIGS. 24a, 24b), which is obtained using the device in FIG. 23. FIG. 24 illustrates the setup and oscilloscope traces of the 1620 nm probe laser when the pump laser is modulated with a square-wave signal with 50% duty cycle, with 100 Hz modulation (FIG. 24a), and with 1 kHz modulation (FIG. 24b). FIG. 24c schematically shows the setup for testing the optical tuning.

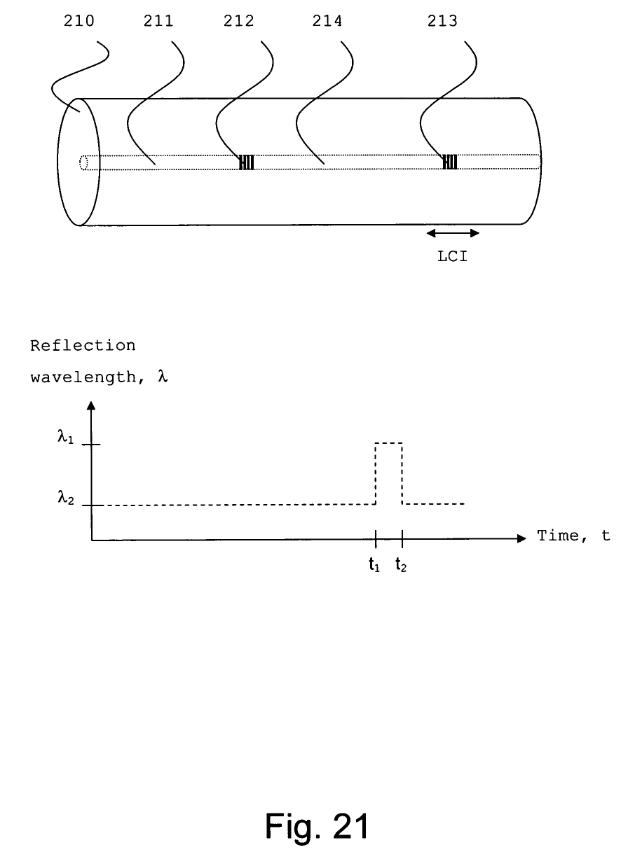

FIG. 21 schematically shows an optical fibre according to a preferred embodiment. The optical fibre 210 comprises a core region 211 and at least one FBG 213 that are positioned in a LCI section of the optical fibre (indicated by ‘LCI’ and arrow in FIG. 21a). The fibre may comprise a second FBG 212.

Preferably the core comprises an optically active material (such as for example one or more rare earths). The active material may be present in a full length of the optical fibre, or in a part of the optical fibre 214. The FGBs may be adapted to reflect light at certain (e.g. predetermined) wavelengths. Preferably, FBG 212 reflects light at a wavelength, λ1, and the reflection wavelength of FBG 213 may be tuned using the LCI section. The optical fibre comprises holes/voids that have been filled (in at least a section of the optical fibre) with liquid crystal. The holes/voids are not shown for reasons of clarity. As illustrated in FIG. 21b, the FBG 213 may be tuned to provide reflectivity at λ1 for a given time (for example, on a ms, ns, or ps scale). The rise and fall times and other characteristics of the FBG during tuning/switching are schematically illustrated in FIG. 21b. In practice, these may have various characteristics depending on the liquid crystal material, the tuning mechanism and other issues. The optical fibre in FIG. 21 may be used as a Q-switched laser, where the cavity formed from the two FBGs when they are reflecting at wavelength, λ1, is only present in the time from t2 to t1.

In another preferred embodiment, an optical fibre comprises a LCI section, wherein the core comprises a FBG. The FBG characteristics may be tuned using the LCI section. For example, the optical fibre may be used in a tuneable dispersion compensation module.

Electrical Tuning:

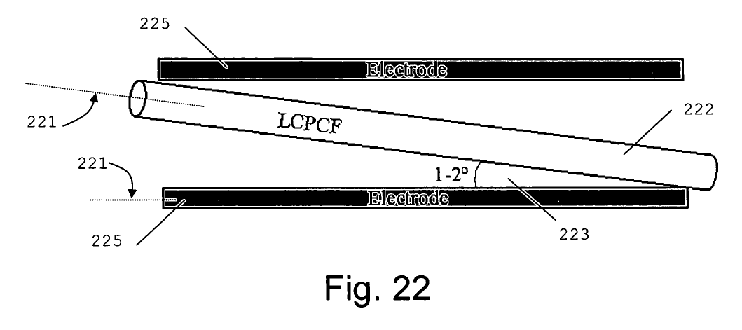

FIG. 22 shows an example of setup for electrical control of properties of an LCI-PCF. FIG. 22 illustrates a tilted electrode configuration, where the longitudinal axis 221 of the LCPF 222 is tilted an angle 223, e.g. a few degrees, such as 1-2 degrees, relative to the plane 224 of the electrodes 225.

For electrical control of the fibre properties, a tilted electrode configuration could be used in order to avoid defects formed by reverse tilt domains in the liquid crystal. These reverse tilt domains can be formed in non-tilted electrodes, where the electrical field is perpendicular to the LC director axis.

Using the tilted electrode configuration, the LC favors to reorient in one direction when the field is turned on, and no defects is formed. The tilted electrode configuration is illustrated on FIG. 22, where a planar alignment of a nematic liquid crystal is assumed, and the tilted electrode favors the LC to turn in one direction. Other types of electrodes may also be used e.g. micro-patterned electrodes and/or electrodes with propagating electrical pulses.

Further, dual frequency nematic liquid crystals, i.e. nematic liquid crystal with a sign change of the dielectric anisotropy as function of frequency, could be used to provide faster and/or better control of the LC. For example, a planar aligned dual frequency nematic LC, with a positive dielectric anisotropy at frequency f1 and a negative dielectric anisotropy at frequency f2, is infiltrated into a PCF and this is placed in the tilted electrode configuration. Applying a field with frequency f2 reorients the LC such that the direction is perpendicular to the electrical field, and, therefore, it has an angle to the fibre axis, which is equal to the electrode tilt angle. This induces a well defined anisotropy in the fibre, which could find use in polarization controlling components.

It will be apparent to those skilled in the art that various modifications and variations of the present invention can be made without departing from the spirit and scope of the invention. Thus, it is intended that the present invention include the modifications and variations of this invention provided they come within the scope of the appended claims and their equivalents.

1. An optical fibre having a longitudinal direction and a cross-section perpendicular thereto, the optical fibre comprises:
core region; and
a micro-structured cladding region, said cladding region surrounding said core region and comprising longitudinally extending cladding elements arranged in a background cladding material,
said cladding elements having cross-sectional sizes which are equal or different,
at least a number of said cladding elements are being arranged in a substantially two dimensional periodic or ring-shaped manner, and
said at least a number of said cladding elements are filled in at least one longitudinal section of the optical fibre with a liquid crystal material, and
the optical fibre exhibits photonic bandgap effect in said at least one longitudinal section for at least one phase state of the liquid crystal material.

2. An optical fibre according to claim 1 wherein said liquid crystal material comprises a liquid crystal dopant material for modifying its optical properties.

3. An optical fibre according to claim 2 wherein said liquid crystal dopant material is selected from the group of azobenzene or anthraquinone dyes and combinations thereof.

4. An optical fibre according to claim 1 wherein said liquid crystal material may be switched between mesophases, such as for example between a smectic and a chiral nematic mesophase.

5. An optical fibre according to claim 4 wherein said optical fibre is adapted to allow switching between mesophases being actuated by thermal, electrical and/or optical means.

6. An optical fibre according to claim 1 wherein the optical fibre comprises one or more active materials for providing lasing action.

7. An optical fibre according to claim 6 wherein said core region and/or at least a part of said cladding background material comprises an active material, preferably silica doped with a rare earth element, most preferred silica doped with Erbium, Ytterbium, Neodymium, Holmium, Thulium, Samarium or combinations thereof.

8. An optical fibre according to claim 1 wherein substantially all cladding elements have substantially equal d/Λ ratio, d being a maximum cross sectional-dimension of a cladding element, such as a diameter, and Λ being the minimum centre-centre distance between said cladding elements.

9. An optical fibre according to claim 1 wherein the ratio d/Λ of a maximum cross sectional-dimension of a cladding element to the minimum centre-centre distance between said cladding elements is in the range from 0.25 to 0.5.

10. An optical fibre according to claim 1 wherein a maximum dimension d of said cladding elements is in the range from 0.5 μm to 7 μm, such as from 1 μm to 5 μm, such as from 1 μm to 2 μm or from 3 μm to 5 μm.

11. An optical fibre according to claim 1 wherein the minimum centre-centre distance between said cladding elements is in the range from 1 μm to 20 μm, such as from 2 μm to 10 μm, such as from 3 μm to 5 μm.

12. An optical fibre according to claim 1 wherein the core and/or cladding regions comprise silica.

13. An optical fibre according to claim 1 wherein the internal surfaces of at least some of the cladding elements, such as holes, at least over a part of their longitudinal extension, are coated with a layer of a material providing a specific anchoring between the liquid crystal material and the cladding background material.

14. An optical fibre according to claim 13 wherein materials used for coating are selected from the group consisting of polyamides, polyimides or lipids such as phosphatidylcholine and combinations thereof.

15. An optical fibre according to claim 1 further comprising a fibre Bragg grating adapted to reflect light at a wavelength λ.

16. An optical fibre according to claim 15 wherein said fibre Bragg grating is located in said longitudinal section of the fibre comprising liquid crystal material.

17. A tuneable article, said tuneable article comprising a liquid crystal infiltrated optical fibre according to claim 1 and means for controlling the phase state of the liquid crystal material.

18. An article according to claim 17 wherein said controlling means comprises an optical control signal and/or an electrical control signal.

19. An article according to claim 17 wherein said article operates at a predetermined signal wavelength, λs, and said control signal is supplied by pump light being coupled to said optical fibre, said pump light having a wavelength, λp, being different from λs.

20. An article according to claim 19 wherein said pump light is coupled to the core of said optical fibre.

21. An article according to claim 17 wherein said optical fibre comprises an unfilled longitudinal section having cladding elements being voids and a filled longitudinal section having liquid crystal filled cladding elements, and said pump light being coupled to an end of said unfilled longitudinal section.

22. An article according to claim 17 wherein said pump light propagates in said unfilled longitudinal section.

23. An article according to claim 17 wherein said controlling means comprise a second optical fibre being spliced to the liquid crystal infiltrated optical fibre, said second optical fibre providing said pump light.

24. An article according to claim 17 wherein said controlling means further comprises a wavelength combining optical device combining light at λp and λs.

25. An article according to claims 17 wherein said optical fibre comprises a first fibre Bragg grating located in said longitudinal section of the fibre comprising liquid crystal material and wherein the characteristics of said first fibre Bragg grating may be varied using said means for controlling the phase state of the liquid crystal material.

26. An article according to claim 25 wherein the variation in characteristics of said first fibre Bragg grating is used to implement a tuneable dispersion compensation module.

27. An article according to claim 25 wherein said optical fibre comprises a further fibre Bragg grating adapted to reflect a wavelength λ1 and wherein the characteristics of said first fibre Bragg grating are adapted to reflect a wavelength λ1 for a specific time interval Δt.

28. An article according to claim 17 wherein said means for controlling the phase state of the liquid crystal material comprise a resulting electric field defining an angle with a longitudinal direction of the optical fibre that is different from 90°, such as a few degrees different, such as one or 2 degrees different.

29. An article according to claim 17 wherein said liquid crystal material comprises material with a positive dielectric anisotropy at frequency f1 and a negative dielectric anisotropy at frequency f2 and said means for controlling the phase state of the liquid crystal material are adapted to apply an electric field at frequencies f1 and f2, respectively.

30. A method of preparing an optical fibre with tuneable optical properties, the optical fibre having a longitudinal direction and a cross-section perpendicular thereto, the method comprising:
providing a micro-structured optical fibre having a core region and a cladding region surrounding the core region, the cladding region comprising a predetermined arrangement and size of holes/voids;
providing a liquid crystal material that is capable of being in different phase states; and
introducing said liquid crystal material into at least a part of said number of holes/voids over at least one longitudinal section of the optical fibre.

31. A method according to claim 30 further comprising the step of providing that said optical fibre exhibits photonic bandgap effect in said at least one longitudinal section for at least one phase state of the liquid crystal material.

32. A method according to claim 30 wherein said liquid crystal material comprises a liquid crystal dopant material for modifying its optical properties, said liquid crystal dopant material being selected from the group of azobenzene or anthraquinone dyes and combinations thereof.

33. A method of preparing an optically tuneable article according to claim 17, the method comprising:
providing a liquid crystal infiltrated optical fibre; and
connecting one end of a second optical fibre or a fibre WDM component or another optical component to said liquid crystal infiltrated optical fibre by a technique selected from the group of but-coupling, free-space coupling and splicing.

34. Use of an optical fibre having a longitudinal direction and a cross-section perpendicular thereto, the optical fibre comprises:
a core region; and
a micro-structured cladding region, said cladding region surrounding said core region and comprising longitudinally extending cladding elements arranged in a background cladding material,
said cladding elements having cross-sectional sizes which are equal or different,
at least a number of said cladding elements are being arranged in a substantially two dimensional periodic or ring-shaped manner, and
said at least a number of said cladding elements are filled in at least one longitudinal section of the optical fibre with a liquid crystal material, and
the optical fibre exhibits photonic bandgap effect in said at least one longitudinal section for at least one phase state of the liquid crystal material or an optical fibre produced in a method according to claim 30 in an optical switch, in an optical polarization controller, in an optical tuneable birefringent element, in an compensator for polarization-mode dispersion, in a tuneable optical filter, in a tuneable dispersion compensating module, in an optical communication system, in an optical fibre laser such as a Q-switched laser, or in an optical fibre amplifier, or in one or more parts thereof.

35. Use of a tuneable article said tuneable article comprising a liquid crystal infiltrated optical fibre having a longitudinal direction and a cross-section perpendicular thereto, the optical fibre comprises:
a core region; and
a micro-structured cladding region, said cladding region surrounding said core region and comprising longitudinally extending cladding elements arranged in a background cladding material,
said cladding elements having cross-sectional sizes which are equal or different,
at least a number of said cladding elements are being arranged in a substantially two dimensional periodic or ring-shaped manner, and
said at least a number of said cladding elements are filled in at least one longitudinal section of the optical fibre with a liquid crystal material, and
the optical fibre exhibits photonic bandgap effect in said at least one longitudinal section for at least one phase state of the liquid crystal material;
and means for controlling the phase state of the liquid crystal material or an optically tuneable article produced in a method according to claim 33 in an optical switch, in an optical polarization controller, in an optical tuneable birefringent element, in an compensator for polarization-mode dispersion, in a tuneable optical filter, in a tuneable dispersion compensating module, in an optical communication system, in an optical fibre laser such as a Q-switched laser, or in an optical fibre amplifier, or in one or more parts thereof.
